(19) United States
(12) Patent Application Publication
(10) Pub. No.: US 2014/0097221 A1
(43) Pub. Date: Apr. 10, 2014

(54) CAR ROOF STORAGE COMPARTMENT WITH A CLOSED-END ZIPPER

(71) Applicant: Ming-Shun Yang, Taipei (TW)

(72) Inventor: Ming-Shun Yang, Taipei (TW)

(21) Appl. No.: 13/645,131

(22) Filed: Oct. 4, 2012

(51) Int. Cl. B60R 9/055

(52) U.S. Cl. CPC B60R 9/055
USPC 224/328

(57) ABSTRACT

A car roof storage compartment includes a bottom member shaped as one half of a clamshell; a top member shaped as the other half of the clamshell, and a closed-end zipper. The edge of the bottom opening of the top member is combined with the bottom member at the position that lower than the top opening of the bottom member by sliding the closed-end zipper, that can prevent rain from entering the car roof storage compartment. The closed-end zipper can be slid in a desired direction in order to change the opening side of the top member. This can increase use convenience. The top member can be separated from the bottom member. Thereafter, the top members and the bottom members can be separated respectively for stacking storage purpose. This has the advantages of facilitating storage, decreasing volume, saving storage space, and decreasing transportation cost for distribution.

### BACKGROUND OF THE INVENTION

1. Field of the Invention

The invention relates to car roof storage compartments and more particularly to a car roof storage compartment mounted on a car roof for storing goods, the car roof storage compartment having a closed-end zipper for allowing closing of the zipper at both ends in a closed state of the car roof storage compartment.

2. Description of Related Art

More and more people and/or families own automobiles (i.e., cars) as income grows rapidly. Further, people take leisure as means of recreation and refreshing in the weekend after five-day work. It is often that a person may drive a car to a scenic area for leisure and even barbeque.

It is typical for a driver putting many personal articles, food, and even a bicycle in the trunk prior to starting a journey. Typically, a car has five seats. A van or stage wagon is designed to take more passengers than a car. It is often that passenger space is greatly reduced after many passengers seating in the seats. The reduced space means less space is available for storing personal articles, etc. One solution is employing a roof of the car as a space for storing excessive articles (i.e., providing a car roof storage compartment).

Car roof storage compartments take many forms which can be classified as soft and hard types. Typically, a soft car roof storage compartment is made from waterproof canvas. However, the soft car roof storage compartment does not has a streamlined contour, resulting in a great increase in the resistance when the car moves through air. Further, the soft car roof storage compartments are not rugged sufficiently to withstand foreign force exerting thereon. Thus, articles stored in the soft car roof storage compartment are liable to damage. Furthermore, racks and additional structures are required to provide on roof of car for mounting the soft car roof storage compartment.

Regarding hard car roof storage compartments, they are made from hard material such as ABS plastic steel, thermosetting plastics, or composite material. The hard car roof storage compartments are streamlined so as to offer the least resistance when the car moves through the air. The hard car roof storage compartment typically has a curved top and a complementary base together forming a shell-like structure. The structure is hinged by providing a hinge along joining sides of the top and the base. Alternatively, a hinged hard car roof storage compartment is formed by hingedly joining the top and the base together in the manufacturing process. However, the typical hard car roof storage compartments only can be opened or closed along a preset direction (i.e., one-way opening or closing). This can cause inconvenience in use. Further, it is not adapted to detach from the car roof in an inoperative position. Furthermore, detaching or adapting to assemble of a plurality of the hard car roof storage compartments is not possible, resulting in a great increase of the storage space when they are detached from the car roof. Moreover, as the volume of the hard car roof storage compartments are quite huge, it will increase the delivery cost for distribution, this is always a financial burden to people (i.e., being expensive in transportation).

Thus, the need for improvement still exists.

### SUMMARY OF THE INVENTION

It is therefore one object of the invention to provide a car roof storage compartment, the car roof storage compartment having a closed-end zipper for allowing opening of a bottom member of the car roof storage compartment from one of four sides of the car roof storage compartment, thereby greatly increasing use convenience. Further, the invention provides a car roof storage compartment which is detachable or adapted to assemble so as to decrease volume and save storage as well as lower transportation cost.

For achieving above objects, the invention provides a car roof storage compartment comprising a bottom member shaped as one half of a clamshell and comprising a top opening; a top member shaped as the other half of the clamshell and comprising a bottom opening, the bottom opening being complementary to the outside of top opening to be partially overlapped to form a closed storage area in the joined bottom and top members; and a closed-end zipper comprising a first row of teeth, an opposite second row of teeth, a first slider, and a second slider; wherein the first row of teeth is provided along the bottom opening, the second row of teeth is provided along the lower position of the top opening, and one of the first and second sliders separates the opposing first and second rows of teeth and the other of the first and second sliders meshes together the opposing first and second rows of teeth when a direction of the first slider's movement is the same as that of the second slider's movement.

Preferably, the bottom member further comprises a bottom and a peripheral wall integrally formed with the bottom of the bottom member, and wherein the top opening is defined by an open top of the peripheral wall of the bottom member.

Preferably, the top member further comprises a top and a peripheral wall integrally formed with the top of the top member, and wherein the bottom opening is defined by an open bottom of the peripheral wall of the top member, the bottom opening of top member is oriented downward to close onto a periphery of the outside of top opening of the bottom member.

Preferably, each of the top member and the bottom member is made of semi-rigid foam material.

Preferably, each of the bottom member and the top member further comprises a plurality of lengthwise ridges or furrows as enhancement ribs.

Preferably, the closed-end zipper is a water-resistant zipper.

Preferably, the first row of teeth comprises a first stop at one end and a second stop at the other end respectively, the second row of teeth comprises a first stop at one end and a second stop at the other end respectively, the first slider enters the first row of teeth at the first stop of the first row of teeth and the second row of teeth enters the second row of teeth at the first stop of the second row of teeth respectively, one of the first and second sliders separates the first and second rows of teeth and the other of the first and second sliders meshes together the first and second rows of teeth, the first slider is prevented from moving out of the second stop of the first row of teeth, and the second slider is prevented from moving out of the second stop of the second row of teeth.

Preferably, the first and second stops of the first row of teeth and the first and second stops of the second row of teeth are disposed at rear ends of both the bottom and top members.

The above and other objects, features and advantages of the invention will become apparent from the following detailed description taken with the accompanying drawings.

### BRIEF DESCRIPTION OF THE DRAWINGS

FIG. 1 is an exploded view of a car roof storage compartment according to the invention, showing a top member, a bottom member, a closed-end zipper, and separation of the top member from the bottom member;

FIG. 2 is a perspective view of the assembled car roof storage compartment in its closed state;

FIG. 3 is a side elevation of the car roof storage compartment of FIG. 2;

FIG. 4 is a perspective view of the car roof storage compartment in its open state and position of the closed-end zipper on the top member and the bottom member;

FIG. 5A is an exploded view of the car roof storage compartment with the bottom member being stacked above the top member showing one of storage methods;

FIG. 5B is a perspective view showing a plurality of top members being stacked;

FIG. 5C is a perspective view showing a plurality of bottom members being stacked;

FIG. 5D is a perspective view showing the stacked bottom members of FIG. 5C being further stacked on the stacked top members of FIG. 5B;

FIG. 6 is a front view of the car roof storage compartment mounted on a car roof with the car roof storage compartment being open from the left side;

FIG. 7 is a view similar to FIG. 6 showing the car roof storage compartment being open from the right side;

FIG. 8 is a side elevation showing the car roof storage compartment mounted on car roof with the car roof storage compartment being open from the front end; and

FIG. 9 is a side elevation showing the car roof storage compartment mounted on the roof of the car with the car roof storage compartment being open from the rear end.

### DETAILED DESCRIPTION OF THE INVENTION

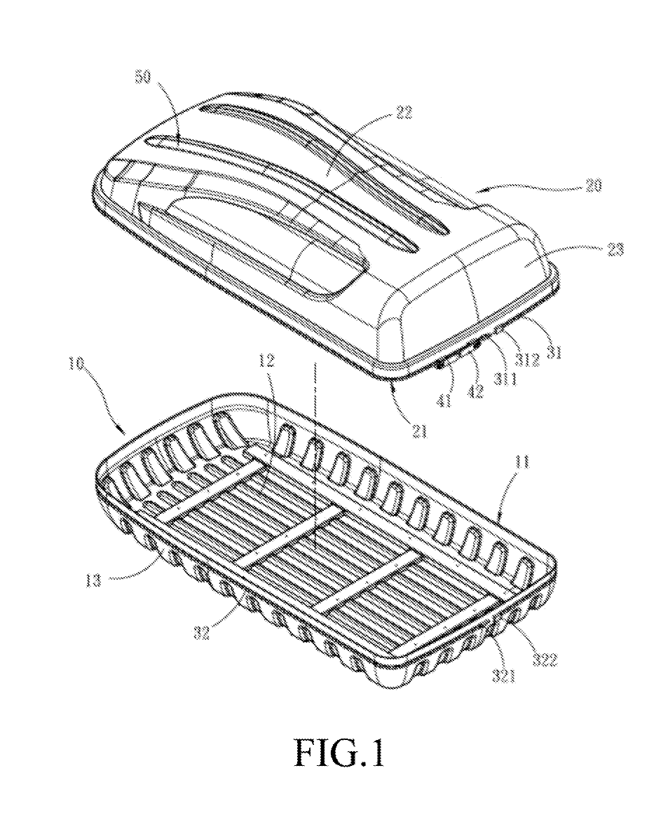

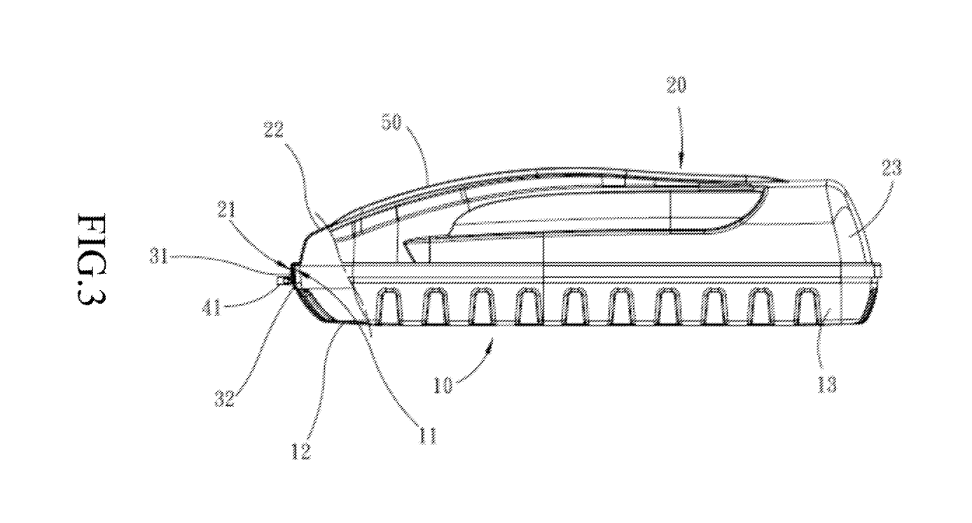

Referring to FIGS. 1 to 9, a clamshell shaped car roof storage compartment mounted on a car roof in accordance with the invention comprises the following components as discussed in detail below.

A bottom member 10 is shaped as one half of the clamshell and comprises a top opening 11, a bottom 12 and a peripheral wall 13 integrally formed with the bottom 12. The top opening 11 is defined by an open top of the wall 13.

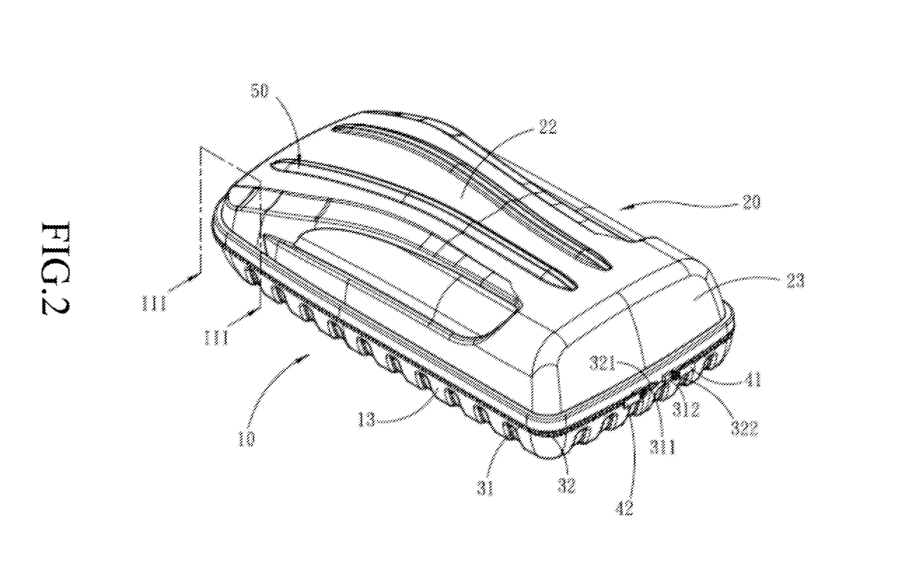

A top member 20 is shaped as the other half of the clamshell and comprises a bottom opening 21, a top 22, and a peripheral wall 23 integrally formed with the top 22. The bottom opening 21 is defined by an open bottom of the wall 23. The bottom opening 21 is complementary to the outside of top opening 11 to be partially joined around to form a closed storage area (see FIG. 2). That is, an inner periphery of the bottom opening 21 is greater than the outside of top opening 11. The position of the bottom edge of the bottom opening 21 is slightly lower than that of the outside of top opening 11 of the bottom member 10 and externally extended a short distance to form a peripheral flange similar to function of eaves for carrying rain away or preventing foreign objects from entering.

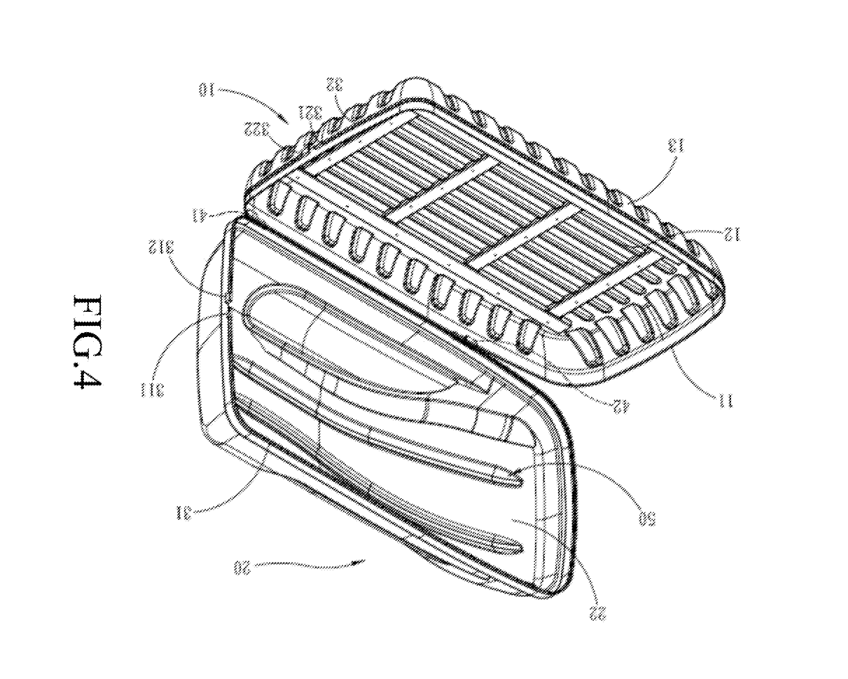

A closed-end zipper 30 comprises a first row of teeth 31, an opposite second row of teeth 32, a first slider 41, and a second slider 42. The first row of teeth 31 is provided along the opening 21 of the top member 20, and the second row of teeth 32 is provided along the position that slightly lower than the top opening 11 of the bottom member 10 (see FIG. 4). The first row of teeth 31 has a first stop 311 at one end and a second stop 321 at the other end respectively. The second row of teeth 32 has a first stop 321 at one end and a second stop 322 at the other end respectively. The first slider 41 enters the first row of teeth 31 at the first stop 311 and the second slider 42 enters the second row of teeth 32 at the second stop 321 respectively. One of the first and second sliders 41, 42 separates the opposing first and second rows of teeth 31, 32 and the other of the first and second sliders 41, 42 meshes together the opposing first and second rows of teeth 31, 32 when the direction of the first slider's movement is the same as that of the second slider's movement. In brief, the closed-end zipper 30 can be closed at both ends. Further, the first slider 41 is prevented from moving out of the second stop 312 of the first row of teeth 31 and the second slider 42 is prevented from moving out of the second stop 322 of the second row of teeth 32 respectively.

Further, the first slider 41 and the second slider 42 are disposed at the first row of teeth 31 (or the second row of teeth 32) when the bottom member 10 is detached from the top member 20 completely. But it is not limited to this. In a preferred embodiment of the invention, the first slider 41 and the second slider 42 are disposed at near the first stop 311 of the first row of teeth 31 on the top member 20.

In a preferred embodiment of the invention, the closed-end zipper 30 is a water-resistant zipper. The first and second rows of teeth 31, 32 are disposed along a periphery of the car roof storage compartment. Preferably, the first and second stops 311 321 of the first row of teeth 31 and the first and second stops 312, 322 of the second row of teeth 32 are disposed at a rear end of the car roof storage compartment facing the rear end of the car for preventing rain water or foreign objects from entering the car roof storage compartment through the gap at a joining position of the first and second row of teeth 31, 32 when the car is driving (see FIG. 2).

As shown in FIG. 4 specifically, for opening the car roof storage compartment, a person may slide the first slider 41 to the position that near the second stop 312 of end of the first row of teeth 31 and the second stop 322 of end of the second row of teeth 32 to the right side of the car roof storage compartment proximate one corner of the car roof storage compartment. Then the person may slide the second slider 32 in a direction opposing the direction of moving the first slider 31 through the rear end, the left side and the front end of the car roof storage compartment until passing the other corner of the right side of the car roof storage compartment (i.e., both the first and second slider 41, 42 at the right side of the car roof storage compartment). Thus, only a portion of the right side is fastened by the closed-end zipper 30. Thereafter, the person may open the unfastened portion of the car roof storage compartment to access items therein.

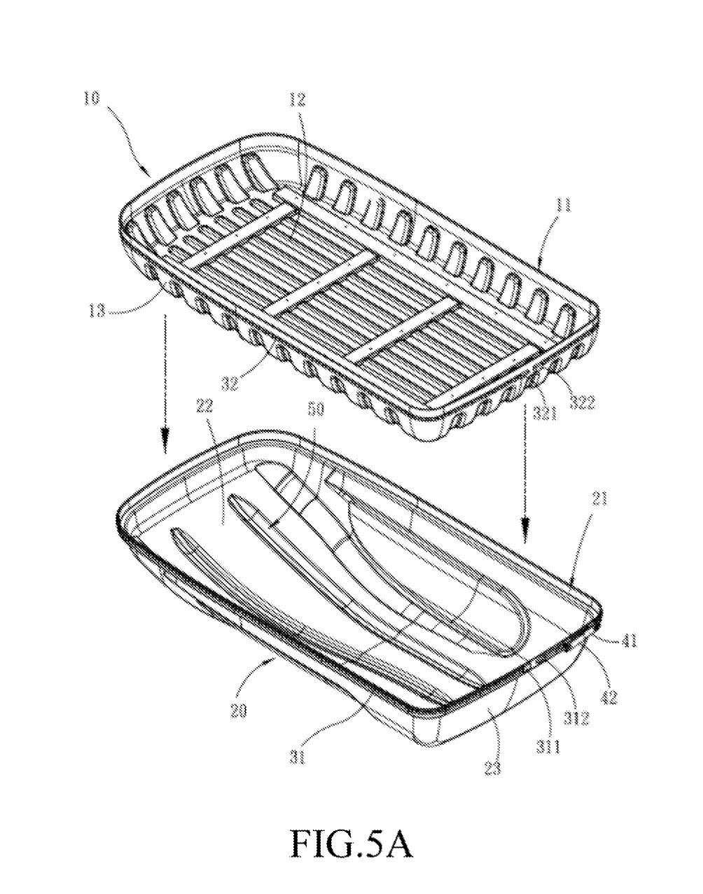

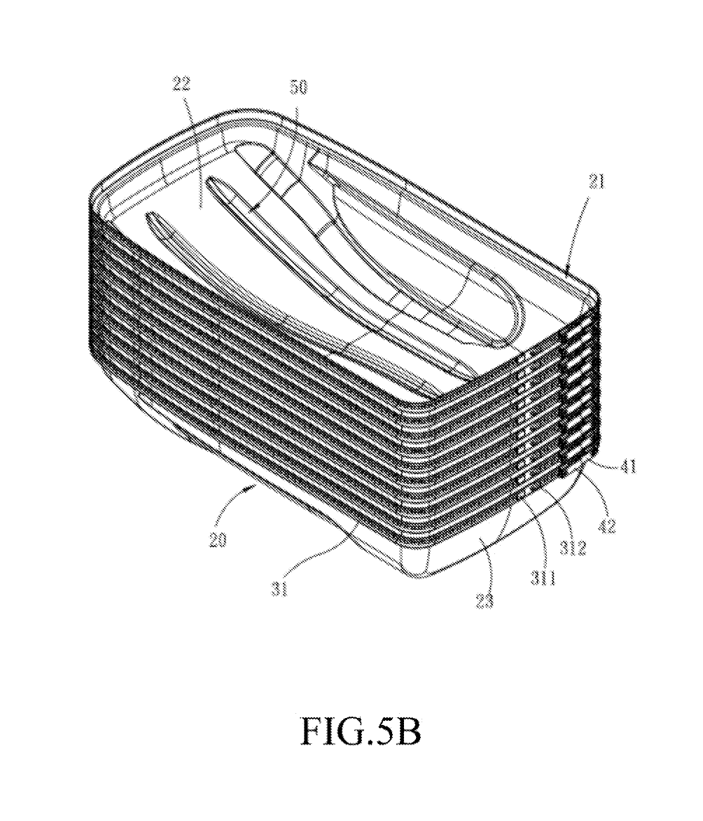

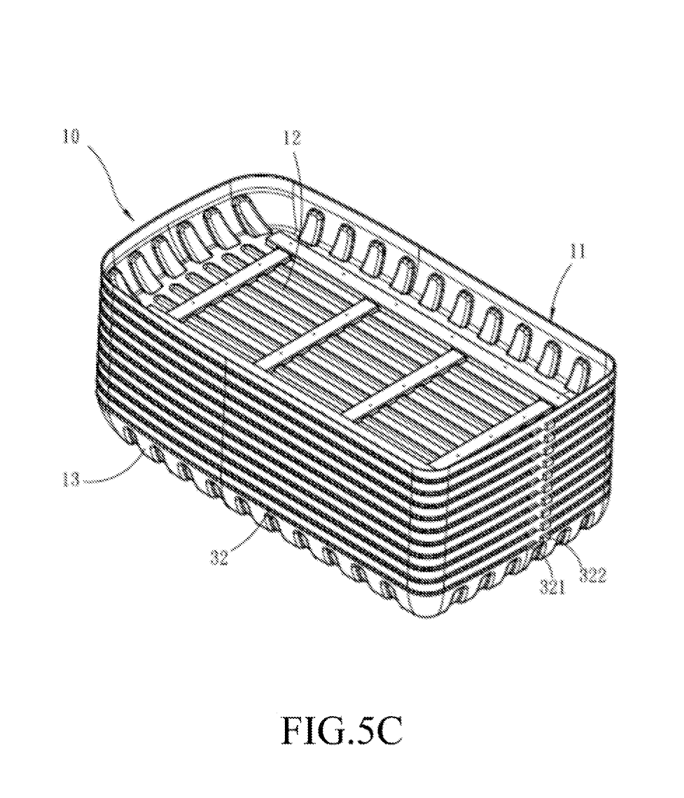

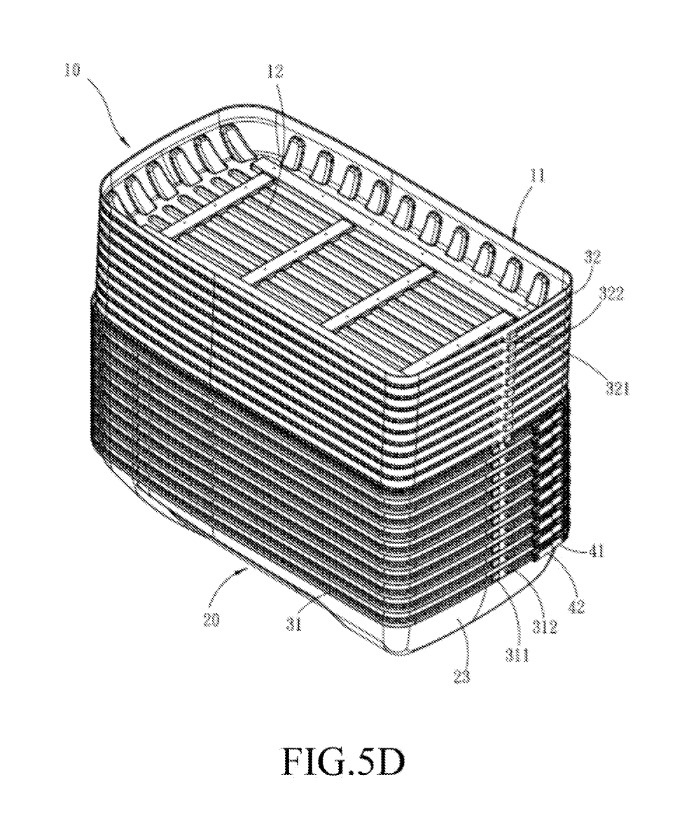

The person may detach the first slider 41 by sliding the first slider 41 out of the first stop 311 of the first row of teeth 31 and detach the second slider 42 by sliding the second slider 42 out of the first stop 321 of the second row of teeth 32 respectively. As a result, the person may stack the bottom member 10 on the bottom opening 21 of the top member 20, thereby separating the bottom member 10 from the top member 20 (see FIG. 5A). Further, the person may stack a plurality of top members 20 for storage (see FIG. 5B). Furthermore, the person may stack a plurality of bottom members 10 for storage (see FIG. 5C). Moreover, the person may put the stacked bottom members 10 on the stacked top members 20 for storage (see FIG. 5D). All of arrangements shown in FIGS. 5A to 5D are for decreasing the space of storing the unused components, facilitating delivery and decreasing the volume of package in order to save transportation cost.

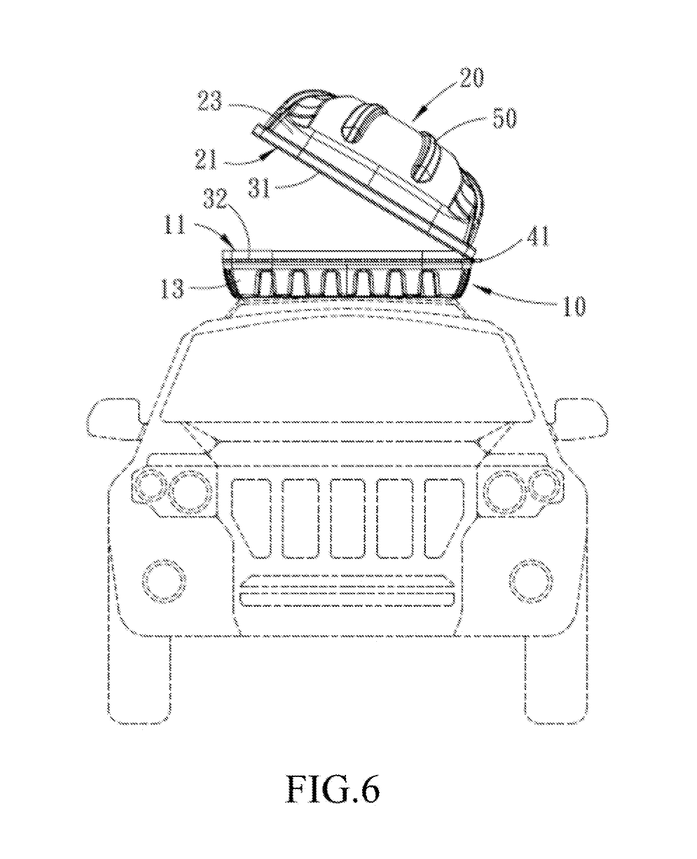

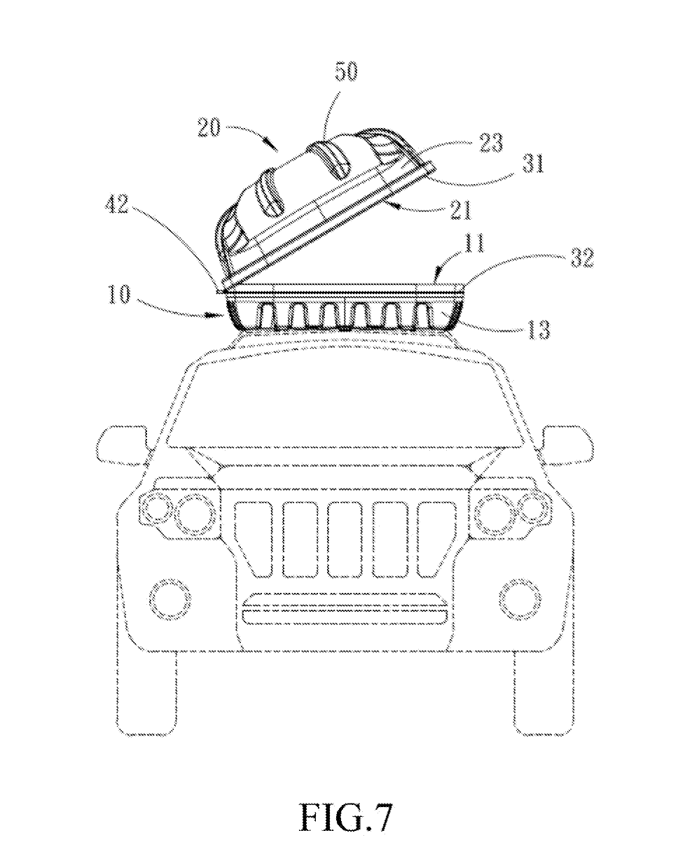

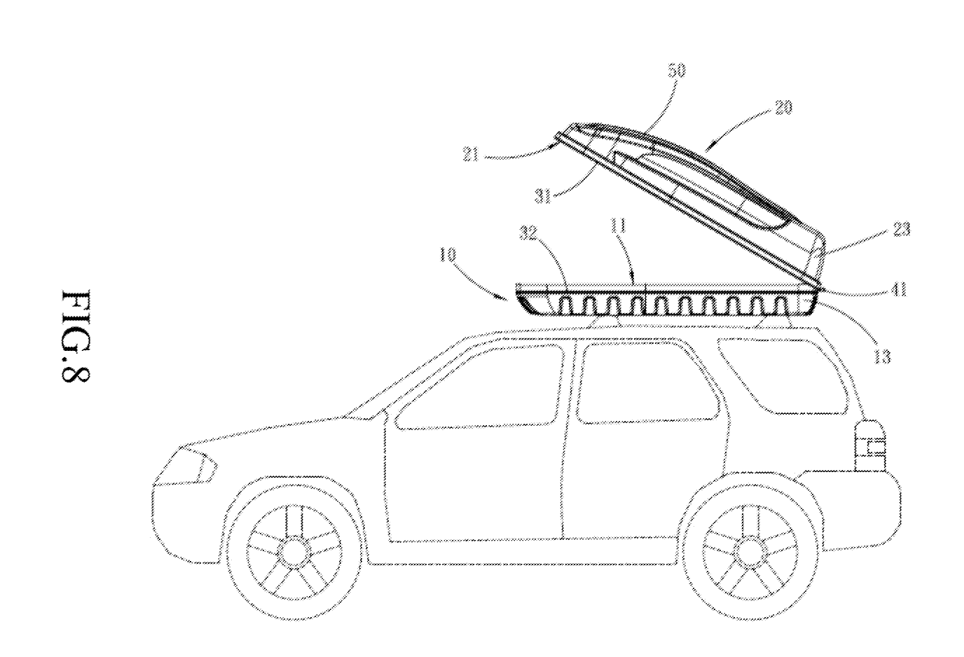

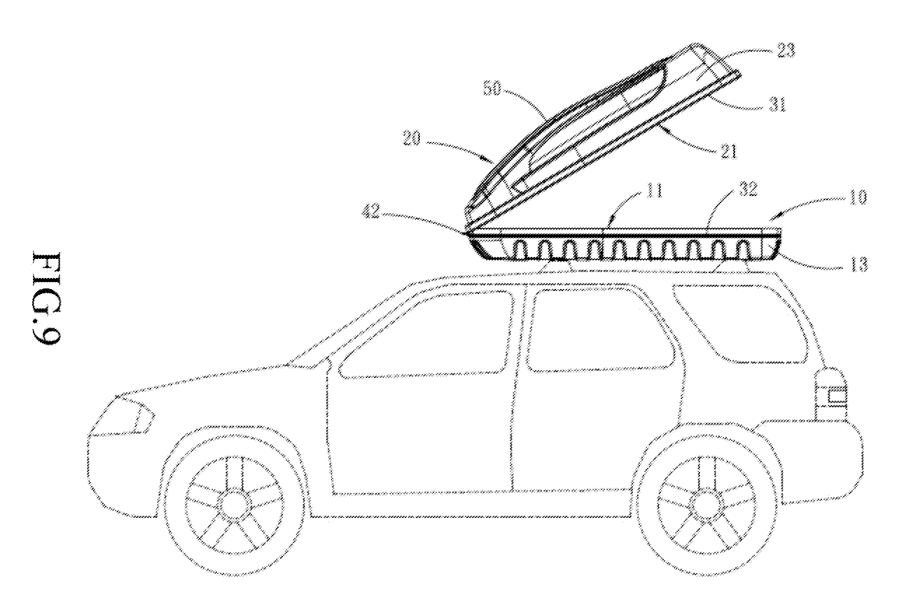

In an open state of the car roof storage compartment, the first slider 41 is disposed the right side of the car roof storage compartment so that the car roof storage compartment can he opened from the left side of the car roof storage compartment (see FIG. 6). In another open state of the car roof storage compartment, the second slider 42 is disposed the left side of the car roof storage compartment so that the car roof storage compartment can be opened from the right side of the car roof storage compartment (see FIG. 7). In still another open state of the car roof storage compartment, the first slider 41 is disposed the rear end of the car roof storage compartment so that the car roof storage compartment can be opened from the front end of the car roof storage compartment (see FIG. 8). In yet another open state of the car roof storage compartment, the second slider 42 is disposed the front end of the car roof storage compartment so that the car roof storage compartment can be opened from the rear end of the car roof storage compartment (see FIG. 9), that can increase use convenience.

In a preferred embodiment of the invention, the top member 20 and the bottom member 10 are made of semi-rigid foam material and streamlined so as to offer the light weight and least resistance when the car moves through the air.

Preferably, both the bottom member 10 and the top member 20 are corrugated. For example, a plurality of lengthwise ridges 50 (or furrows) as enhancement ribs are formed on a top of the bottom member 10 so as to increase the structural strength of the bottom member 10.

The bottom member 10 of the car roof storage compartment can be fastened on two racks on a roof of a car by means of ropes or quick release (see FIG. 6). Other mounting arrangements adapted to different kinds of car are also envisaged by the invention. It is noted that how to mounting the car roof storage compartment on the car roof is the subject of the invention. Accordingly, further detailed description is omitted for purposes of brevity and convenience only, and is not limiting.

It is envisaged by the invention that a reduction of about 80% space of package required for storing the unused car roof storage compartments by stacking can be achieved by utilizing the separable nature of the bottom member 10 and the top member 20.

While the invention has been described in terms of preferred embodiments, those skilled in the art will recognize that the invention can be practiced with modifications within the spirit and scope of the appended claims.

What is claimed is:

1. A car roof storage compartment comprising:
a bottom member shaped as one half of a clamshell and comprising a top opening;
a top member shaped as the other half of the clamshell and comprising a bottom opening, the bottom opening being complementary to the outside of top opening of the bottom member to be partially overlapped to form a closed storage area in the joined bottom and top members; and
a closed-end zipper comprising a first row of teeth, an opposite second row of teeth, a first slider, and a second slider;
wherein the first row of teeth is disposed along the bottom opening, the second row of teeth is disposed along the position that slightly lower than the top opening, and one of the first and second sliders separates the opposing first and second rows of teeth and the other of the first and second sliders meshes together the opposing first and second rows of teeth when a direction of the first slider's movement is the same as that of the second slider's movement.

2. The car roof storage compartment according to claim 1, wherein the bottom member further comprises a bottom and a peripheral wall integrally formed with the bottom of the bottom member, and wherein the top opening is defined by an open top of the peripheral wall of the bottom member.

3. The car roof storage compartment according to claim 2, wherein the top member further comprises a top and a peripheral wall integrally formed with the top of the top member, wherein the bottom opening is defined by an open bottom of the peripheral wall of the top member, and wherein the bottom opening is oriented downward to close onto a periphery of the outside of top opening of the bottom member.

4. The car roof storage compartment according to claim 1, wherein each of the top member and the bottom member is made of semi-rigid foam material.

5. The car roof storage compartment according to claim 1, wherein each of the bottom member and the top member further comprises a plurality of lengthwise ridges or furrows as enhancement ribs.

6. The car roof storage compartment according to claim 1, wherein the closed-end zipper is a water-resistant zipper.

7. The car roof storage compartment according to claim 1, wherein the first row of teeth comprises a first stop at one end and a second stop at the other end respectively, the second row of teeth comprises a first stop at one end and a second stop at the other end respectively, the first slider enters the first row of teeth at the first stop of the first row of teeth and the second row of teeth enters the second row of teeth at the first stop of the second row of teeth respectively, one of the first and second sliders separates the first and second rows of teeth and the other of the first and second sliders meshes together the first and second rows of teeth, the first slider is prevented from moving out of the second stop of the first row of teeth, and the second slider is prevented from moving out of the second stop of the second row of teeth.

8. The car roof storage compartment according to claim 7, wherein the first and second stops of the first row of teeth and the first and second stops of the second row of teeth are disposed at rear ends of both the bottom and top members.
